(19) United States
(12) Patent Application Publication
(10) Pub. No.: US 2010/0297566 A1
(43) Pub. Date: Nov. 25, 2010

(54) DEVICE FOR INJECTING A FUEL/OXIDISER PRE-MIXTURE, COMPRISING MEANS FOR PASSIVE CONTROL OF THE COMBUSTION INSTABILITIES

(75) Inventors: Nicolas Noiray, Paris (FR); Daniel Durox, Igny (FR); Sebastien Candel, Palaiseau (FR); Thierry Schuller, Paris (FR)

Correspondence Address: ARENT FOX LLP, 1050 CONNECTICUT AVENUE, N.W., SUITE 400, WASHINGTON, DC, 20036, US

(73) Assignee: CENTRE NATIONAL DE LA RECHERCHE SCIENTIFIQUE-CNRS, Paris Cedex 16 (FR)

(21) Appl. No.: 12/670,317

(22) PCT Filed: Jul. 23, 2008
(86) PCT No.: PCT/FR08/01092

§ 371 Date: Jul. 27, 2010

(30) Foreign Application Priority Data
Jul. 23, 2007 (FR) 0705344

(51) Int. Cl. F23D 11/00; F02M 61/00

(52) U.S. Cl. 431/159; 239/533.12

(57) ABSTRACT

The invention relates to a multi-point device for injecting a fuel or a fuel/oxidiser pre-mixture into a combustion zone (3) arranged downstream of the device in such a way as to form flames, said device comprising at least one conduit for the flow of the fuel or the pre-mixture towards the combustion zone (3), and means for controlling the flow of the fuel or the pre-mixture running into the combustion zone. Said device is characterised in that the control means are arranged in such a way as to define at least two control openings in the flow conduit, having a non-null determined longitudinal offset ΔX so that, in response to an acoustic load formed upstream of the control means, the flames formed in the combustion zone (3), respectively at the outlet of each control opening, oscillate out of phase.

The invention relates to the field of combustion and more particularly the combustion in a multi-point injection system.

In a conventional way per se, the multi-point injection systems are characterised by a combustion chamber, wherein a fuel or a fuel/oxidiser pre-mixture is injected at several points. The combustion occurs downstream of a multi-point injection system.

The word “fuel” will mean, in the following, both the fuel and also the fuel/oxidiser pre-mixture.

Among the various instabilities playing a role during a combustion reaction, an instability called “acoustic instability” plays a particular part, which results from the coupling between a combustion process and the system acoustics. Now, such instabilities have a negative effect on the behaviour on the system or the facilities implementing combustion.

They occur as waves in the system. As for an example, heating domestic fires, radiant panels used in the drying industry, combustion chambers of the gas turbines or liquid propellant rocket motors, are liable to be instable.

More particularly, the acoustic instability occurs because of a resonant coupling between the flames and the acoustics of the system or the facility. As a matter of fact, when it is submitted to an acoustic excitation (unsteady rate and pressure), the system induces oscillations of the heat release. The light intensity emitted by the free radicals OH*, CH*, C₂* (proportional to the heat release) sinusoidally oscillates about the average position. And the response of the flames to the acoustic excitation leads to an increase in the instability of the combustion system.

The coupling between the combustion and the acoustics of the system can have serious consequences with, more particularly, a deterioration of performances and in some cases, serious damages to the facilities and the environment thereof (vibration of structures, extinction of flames, strong sound radiation, etc.).

In order to prevent damages which might result from this type of instability, control methods are used, with the passive methods being the most current ones. Among these, a method relating to the utilisation of “acoustic dampers” can be cited. Acoustic dampers consist of cavities of the Helmholtz resonators or quarter wave resonators type. Such cavities, more particularly positioned on the periphery of the combustion chambers, make it possible to absorb a part of the acoustic energy, to reduce the quality factor of the system and thus to increase the size of the system stability ranges. However, although they are efficient, such solutions remain costly in terms of space (large overall dimensions) and structural mass.

The invention more particularly aims at remedying the previously described drawbacks of the prior art by providing a combustion system making it possible to eliminate the combustion instabilities and more particularly the instabilities related to the heat-acoustic effects of the resonant coupling of the system implementing combustion.

For this purpose, and according to a first aspect, the invention relates to a multi-point device for injecting a fuel or a fuel/oxidiser pre-mixture into a combustion zone arranged downstream of said device in such a way as to form flames, said device comprising at least one conduit for the flow of the fuel or the pre-mixture towards the combustion zone and means for controlling the flow of the fuel or of the pre-mixture into the combustion zone. The injection device according to the invention is remarkable in that the control means are arranged in such a way as to define at least two control openings in the flow conduit, having a non-null determined longitudinal offset ΔX so that, in response to an acoustic load, the flames formed in the combustion zone respectively at the outlet of each control opening oscillate out of phase. Said openings have distinct longitudinal axes.

Combustion zone means a confined reaction zone such as a combustion chamber, or a non-confined reaction zone.

According to a first embodiment of the invention, the flow conduit comprises a plurality of injection channels having a diameter D provided with an outlet in the combustion zone, and the control means comprise diaphragms respectively positioned transversally in each associated injection channel, the openings of said diaphragms forming the control openings.

In the present invention, a diaphragm means a restriction of the diameter of injection channels. Such restriction can be directly formed by the internal wall of the channels or may be embodied by the positioning of a perforated plate inside the channels.

Advantageously, half the diaphragms are positioned at a distance X1 from the outlet of the associated injection channels, with the other half of the diaphragms being positioned at a distance X2 from the outlet of the injection channels, X2 being different from X1 so as to have a non-null determined ΔX offset.

Advantageously, the diaphragms of the first half of the injectors and those of the second half have openings with the same diameter d. However, some may be provided with non identical opening diameters.

According to a second configuration of the invention, the flow conduit is provided with two series of injection channels respectively provided with an outlet in the combustion zone, with the injection channel for each series comprising an internal wall having a sudden localised enlargement respectively at a different distance from the outlets L12 and L22, said enlargements forming the control openings. The enlargements of each one of the series of injection channels thus have a non-null longitudinal offset.

Advantageously, the injection channels comprise a first zone having diameters D11 and D21 and a second zone having diameters D12 and D22 which are greater than diameters D11 and D21, with the second zone of channels of the first series of injectors having a length which is different from that of the channels of the second series of injectors. This length difference has a non-null offset ΔX. Advantageously, the diameters D11 and D21 are identical (similarly f r D12 and D22), since equality is not at all necessary.

In order to improve the stabilisation of the combustion system provided for the above-mentioned combustion device, swirling elements and arranged in the injection channels downstream of said control means or, as a replacement or in combination, recirculation elements in the shape of a rod, extending longitudinally in the injection channel can also be provided.

According to another configuration of the invention, the control mean comprise a panel positioned transversally in the flow conduit, said panel comprising a surface in which wells are a ranged in such a way as to form transversal surfaces offset with respect to one another, with each of the surfaces being provided with a control opening. The transversal surfaces comprise surface of a panel associated with the bottom of the wells. Like in the preceding configurations, it can also be advantageous to provide at least one swirling element positioned in the flow conduit, downstream of said control means.

Thus, the means for controlling the flow of the fuel or the pre-mixture mainly consist in a sudden localised variation in the diameter of the injection channel in such a way as to form, downstream of the variation in the diameter of the injection channels, swirls moving at the fuel or pre-mixture flowing speed. Such variation in diameter, combined with a position of the variations of each one of the channels, longitudinally offset with respect to one another, leads to offsetting the oscillation of flames in the combustion zone. As they are formed offset, the flames have a phase shift which makes it possible to compensate the acoustic loads.

According to a second aspect, the invention relates to a combustion system comprising a combustion zone associated with an injection device such as mentioned above.

Other objects and advantages of the invention will appear upon reading the following description which is given while referring to the appended drawings, wherein:

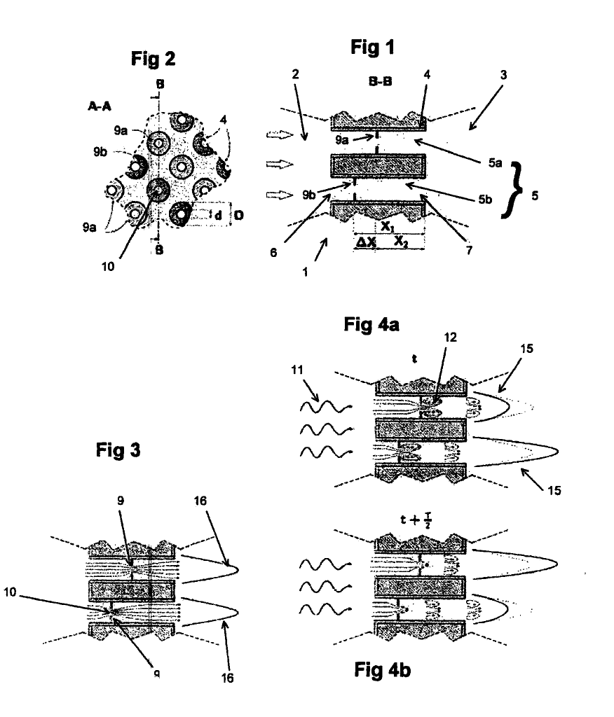

FIG. 1 illustrates a cross-sectional view of a combustion system according to a first configuration of the invention;

FIG. 2 is a partial front view of the combustion system of FIG. 1;

FIG. 3 illustrates the combustion system of FIG. 1 in steady state operation.

FIGS. 4A and 4B show, respectively at moment t and moment t+T/2, the combustion system of FIG. 1 being in forced state operation;

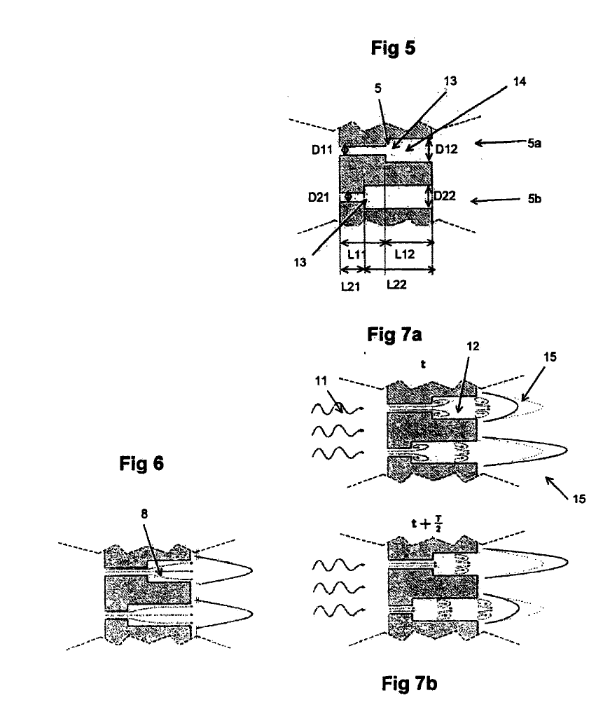

FIG. 5 illustrates a combustion system according to a second configuration of the invention;

FIG. 6 illustrates the combustion system of FIG. 5 in steady state operation;

FIGS. 7A and 7B show, respectively at moment t and moment t+T/2, the combustion system of FIG. 5 in forced state operation;

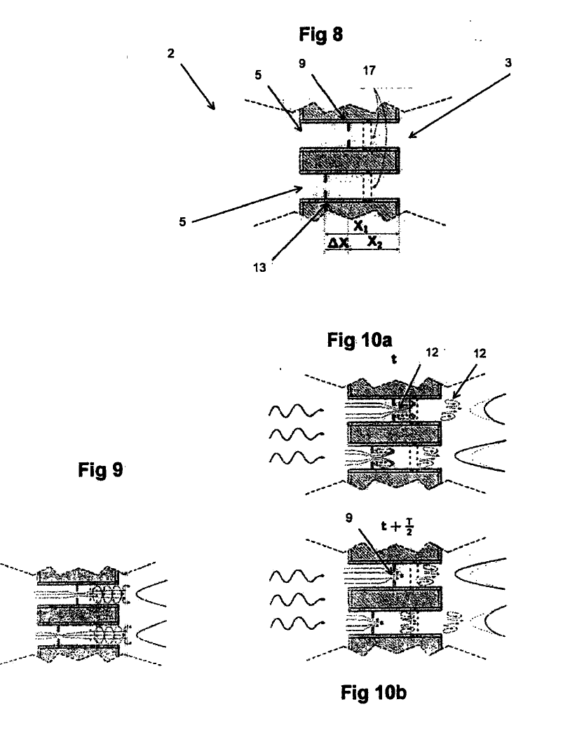

FIG. 8 illustrates a cross-sectional view of a combustion system according to a third configuration of the invention;

FIG. 9 illustrates the combustion system of FIG. 8 in steady state operation;

FIGS. 10A and 10B show, respectively at moment t and moment t+T/2, the combustion system of FIG. 8 in forced state operation;

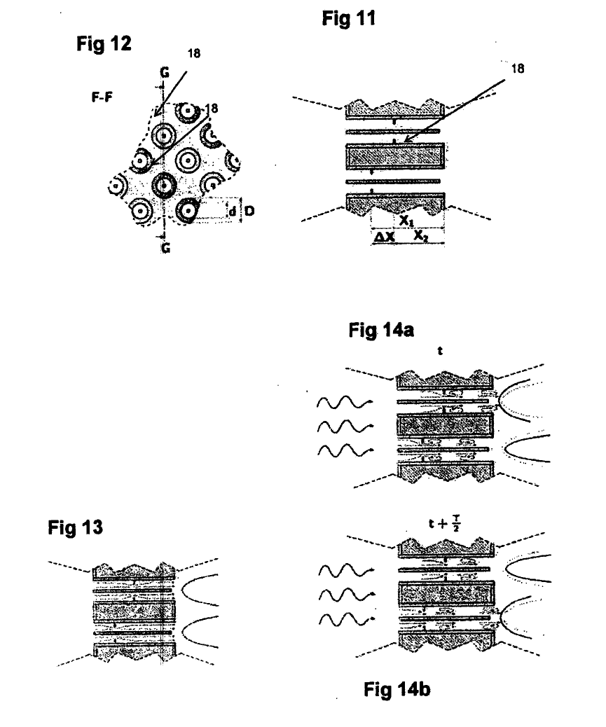

FIG. 11 illustrates a cross-sectional view of a combustion system according to a fourth configuration of the invention;

FIG. 12 is a partial front view of the combustion system of FIG. 8;

FIG. 13 illustrates the combustion system of FIG. 12 in steady state operation;

FIGS. 14A et 14B show, respectively at moment t and moment t+T/2, the combustion system of FIG. 12 in forced state operation;

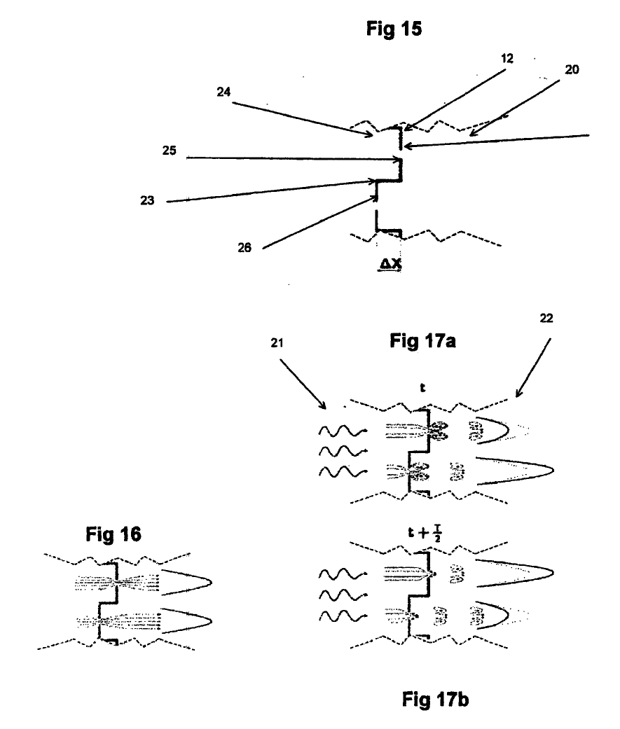

FIG. 15 illustrates a cross-sectional view of a combustion system according to a fifth configuration of the invention;

FIG. 16 illustrates the combustion system of FIG. 15 in steady state operation;

FIGS. 17A and 17B show, respectively at moment t and moment t+T/2, the combustion system of FIG. 16 in forced state operation;

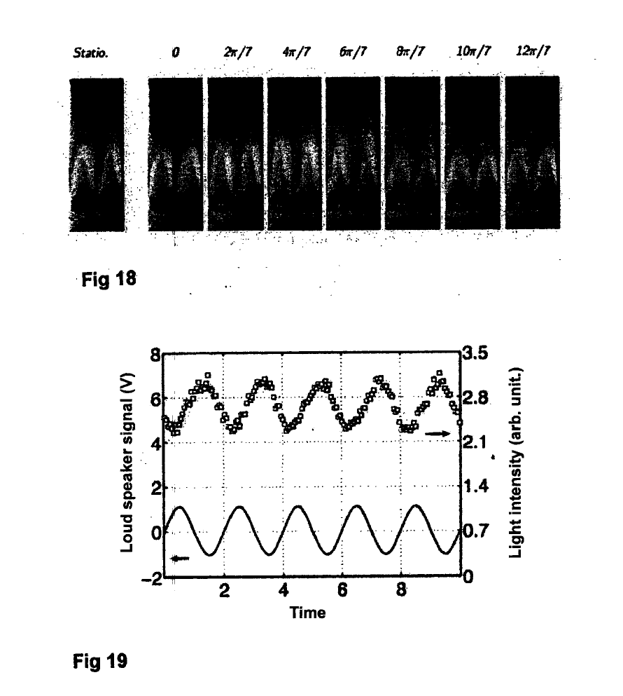

FIG. 18 illustrates the oscillatory behaviour of flames in steady state operation and in forced state operation in the combustion system of FIGS. 1 to 3 and 4A and 4B when the latter comprises no diaphragm;

FIG. 19 illustrates the signal of an acoustic excitation and the associated response of the flames in the combustion system of FIGS. 1 to 3 and 4A and 4B when the latter comprises no diaphragm;

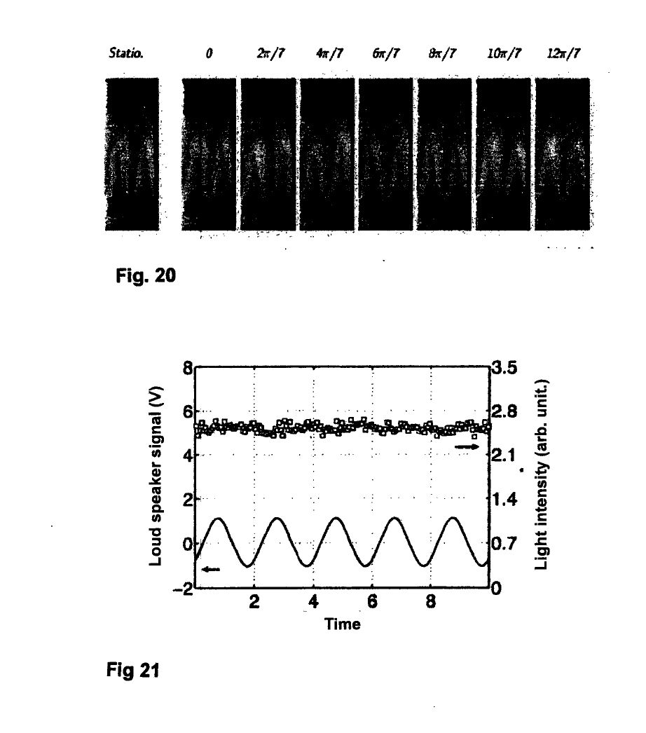

FIG. 20 illustrates the oscillatory behaviour of flames in steady state operation and in forced state operation in the combustion system of FIGS. 1 to 3 and 4A and 4B when the combustion system comprises diaphragms; and

FIG. 21 illustrates the signal of an acoustic excitation and the associated response of the flames in the combustion system of FIGS. 1 to 3 and 4A and 4B when the combustion system comprises diaphragms.

In relation with FIGS. 1 to 3 and 4A and 4B, a combustion system 1 is described which comprises a fuel inlet chamber 2 and a combustion zone 3, said zones 2, 3 being connected by a plurality of injectors 4 intended to inject into the combustion zone 3 the fuel or a fuel/oxidiser pre-mixture.

Each injector 4 comprises an injection channel 5 for injecting the fuel provided with an inlet opening 6 opening into the inlet chamber 2 and an outlet opening 7 opening into the combustion zone 3. The injection channel 5 advantageously has a circular section having a diameter D.

Each injection channel 5 comprises means enabling the control of the fuel injection into the combustion chamber 3.

Generally speaking, the control of the fuel injection is provided by a sudden variation in the diameter of the injection channel 5 at a given point on the length of said channel. In the described embodiment, the variation in the diameter is obtained using a diaphragm 9 provided with one hole 10, preferably a central one. The hole 10 has a diameter d smaller than the diameter D of the injection channels. The thus configured hole 10 is a control port 10 of the associated injection channel. The diaphragm 9 is positioned transversally inside the injection channel 5 of the injector 4.

In the embodiment described, the combustion system 1 comprises two series of injectors, each series being distinct by the position of the diaphragms 9 in the associated injection channels 5. Thus, the combustion system 1 comprises a first series of injectors 4a the diaphragms 9 of which are located at a distance X1 from the outlet opening 7 of the injection channel 5a and a second series of injectors 4b the diaphragms 9 of which are located at a distance X2 from the outlet opening 7 of the injection channel 5b (FIG. 1), with the distance X2 being different from the distance X1. Thus, as can be seen in FIG. 1, the diaphragms 9 are positioned offset with respect to one another. As will be seen subsequently, this diaphragm offset makes it possible to have the flames at the outlet of channels 5a and 5b at the first and second series of injectors 4a, 4b out of phase, so as to eliminate the thermo-acoustic effects of the “combustion/acoustics” coupling of the combustion system 1.

The distances X1 and X2 are selected as a function of the power of the injectors, and thus of the diameter D of the injectors and the flow rate of the fuel going through the injectors. More particularly, the distances X1 and X2 are defined as a function of the ratio of the control ports 10 and the injection channels 5a, 5b (d/D) diameters, and the average rate per injector. They are chosen in such a way that, when the combustion system 1 is in steady state operation, the fuel, in the form of jets 8, flows again along to the walls of the injection channels prior to their leaving through the opening 7 into the combustion chamber 3 (FIG. 3). Such a configuration makes it possible to guarantee an identical loss of head for both series of injectors 4a and 4b, thus offering in steady state operation, an equal flow rate going out into the combustion chamber 3, whatever the series of injectors.

FIGS. 4A and 4B illustrate the behaviour of the combustion system 1 when the latter is submitted to interferences 11 in the flowing of the fuel at various moments. As previously mentioned, such interferences 11 are more particularly shown by fluctuations in the flow leaving the inlet chamber 2 and passing through the injectors 4a and 4b. The frequency f of such interferences 11 corresponds to one of the proper acoustic modes of the combustion system 1. The wavelength associated thereto is generally high, considering the dimensions of the injector. The presence of the diaphragm 9 in the injection channel 5 of each one of the injectors 4 imparts at transfer between the acoustic energy and the kinetic energy of hydrodynamic modes of the flow. A release of circular swirls 12 in the mixture layer created by the diaphragm 9 results therefrom. As the acoustic oscillations of the flow from the inlet chamber 2 propagate at the speed of sound, they are thus transformed into hydrodynamic oscillations of the flow “transported” by the annular swirls 12, at a speed which is close to that of the average flow, which itself remains much lower than the speed of sound. The time taken by the hydrodynamic oscillations to reach the outlet of each channel 5 depends on the distance between the diaphragms 9 and the channel 5 outlet.

Different convective delays are obtained by positioning diaphragms 9 in offset positions within the injection channel 5, depending on whether the first series of injectors 4a or the second series of injectors 4b is concerned. Convective delay means the ratio of the distance between the diaphragm 9 and the outlet opening of a channel (Xi) with the propagation speed of an annular swirl 12 (Vt).

Thus, for the first series of injectors 4a, the convective delay is t=X1/Vt, for the second series of injectors 4b, the convective delay is t=X2/Vt.

An offset ΔΦ can thus be created between the injectors of the first series 4a and the injectors of the second series 4b, where:

$$Δφ = 2 pf ( {t}_{1} - {t}_{2} ) = \frac{2 pf}{Vt} ( {X}_{1} - {X}_{2} ) = \frac{2 pf}{Vt} DX$$

The offset ΔX between the diaphragms 9 of the injectors of each series 4a and 4b is then selected such that, at a given frequency f, the total fluctuation of the acoustic rate at the inlet chamber 2 gives hydrodynamic fluctuations in phase opposition from one series of injectors to another, at the combustion zone 3.

The offset ΔX thus makes it possible to uncouple the flames at the outlets of the first series of injectors from the flames at the outlets of the second series of injectors and to have them out of phase. Such an offset, which compensates the acoustic loads generated in the inlet chamber 2, thus leads to the stabilisation of the combustion system 1. It should be noted that the stabilising effect is obtained with any phase difference so long as the latter is not null.

So, whatever the series of injectors, the flames in steady state operation are identical (FIG. 3). A contrario, in forced state operation (acoustic loads or interferences), the flames have a phase difference which thus compensates for the acoustic loads imparted to the combustion system and thus make it possible to prevent a proper mode of said system to appear.

FIG. 18 illustrates the oscillatory behaviour of flames in steady state operation (photograph on the left) and in forced state operation (seven photographs starting from the right) when the injection channels comprise no diaphragm. Without any hydrodynamic compensation, it can be noted that in forced state operation, the flames formed at the injection channel outlets oscillate in phase. Similarly, the light intensity emitted by the radicals OH*, proportional to the release of heat, sinusoidally oscillates about the average position (FIG. 19, signal shown the highest on the diagram) in response to a loud-speaker signal (acoustic excitation) (FIG. 19, a signal shown the lowest on the diagram): the flames respond to the acoustic excitation.

FIG. 20 illustrates the oscillatory behaviour of the flames in steady state operation and in forced state operation when the injection channels each comprise a diaphragm. Thus, as the channels are provided with a hydrodynamic compensation, it can be noted that the flames oscillate in opposite phase. In addition, the light intensity emitted by the radicals OH*, proportional to the release of heat, no longer oscillates about the average position (FIG. 21, the signal being represented the highest on the diagram). The flames thus no longer respond to the acoustic excitation (FIG. 21, this signal being shown the lowest on the diagram) when the injection channels are provided with diaphragms. A perfect stability of the system in the natural state results therefrom. In addition, it can be seen in FIGS. 19 and 21 that the average level of heat release is identical to the one when the channels have no diaphragm. The natural state is thus not affected by the presence of diaphragms in the channels.

In cases of pre-mixed combustion, the fluctuations of the flame heat release are directly related to the fluctuations of the pre-mixture flow. If the fluctuations of flows at each series of injectors are out of phase, the fluctuations of the heat release will also be out of phase with the same difference ΔΦ.

In the following, two exemplary calculations of the dimensions in two different industrial situations are given as examples.

The first situation is that of a multipoint injection having small dimension injectors (diameter D of the order of 2 millimetres) positioned in a system having a natural instability at a frequency f of the order of 500 Hz. Without any hydrodynamic compensation, i.e. in the absence of injection control means such as diaphragms, the system oscillates at the frequency f of the order of 500 Hz. In order to eliminate said instability, the injection channels 5a, 5b of each injectors 4a, 4b are respectively provided with diaphragms 9a, 9b having an opening diameter d imparting a jet speed V, at said plates, of the order of 6 m/s. If the annular swirls 12 propagation speed is such that Vt is of the order of V/2, then the control diaphragms of the first series of injectors should be offset with respect to those of the second series of injectors by 3 millimetres (ΔX=V/4f).

The second situation is that of a multipoint injection having large dimension injectors (diameter D of the order of 30 millimetres) positioned in the system having a natural instability at a frequency f of the order of 150 Hz. Without any hydrodynamic compensation, such geometry has a natural instability at a frequency f of the order of 150 Hz. In order to eliminate such instability, the channels of each injector are provided with control diaphragms having a diameter d imparting a jet speed V at the level of the control diaphragms of the order of 15 m/s. Consequently, the control plates of the first series of injectors should be offset with respect to the second series of injectors by 30 millimetres.

Other configurations of means for controlling the flow of fuel into the combustion chamber having the same advantages and characteristics as the control diaphragms described hereabove can be provided.

More particularly, injectors 4 can be provided, the injection channels 5 of which are respectively provided with a sudden variation in diameter (FIGS. 5, 6, 7A and 7B). More particularly, said channels have a sudden enlargement 13, at a given point along the length of the channel 5 in the jet flowing direction 8. As for the control diaphragms, the injection device will comprise at least two series of injectors 4a, 4b, with the injectors of a series being distinguished from another series through the position of the associated channels 5a, 5b of the enlargement of the channel. Thus:
the channels 5a of the injectors of a first series 4a comprise a first flow zone having a diameter D1 and a length L11 and a second flow zone 14 having a diameter D2 and a length L12, D2 being greater than diameter D1; and
the channels 5b of the injectors of a second series 4b comprise a first flow zone having a diameter D1 and a length L21 and a second flow zone 14 having a diameter D2 and a length L22, D22 being greater than diameter D21 and L21 being different from length L11.

This offset position of the variation in diameter from one injector to another makes it possible, as mentioned above, to compensate, in forced state operation, the acoustic loads of the combustion system 1.

As mentioned above, the position of the enlargement in the channels 5a, 5b as well as the position thereof offset by an injector from one series to another, are provided in such a way that, in steady state operation, the loss head is almost identical. In other words, the jets 8 of the fuel should have adhered to the walls of the channels prior to their going out into the combustion zone 3, with the flames in the combustion zone then being identical, whatever the series of injectors 5a or 5b (FIGS. 5 and 6).

FIGS. 7A and 7B illustrate the response of injectors 4a, 4b of each series when the latter are submitted to acoustic loads from the inlet chamber 2 (in forced state operation). Because of the sudden enlargements of the channels, annular swirls 12 are formed in the flow zone 14. The channel of the injector of the first series comprising an enlargement positioned downstream of that of the channel of the injector of the second series, the flames 15 formed at the outlet of said injectors are out of phase which makes it possible, as seen previously, to compensate the acoustic loads from the inlet chamber 2. FIGS. 7A and 7B more particularly illustrate the flames 15 at the outlet of the injectors of the first and the second series at moment t and moment t+T/2, with the latter in opposite phase. The dimensions of the difference L12-L22 (ΔX) is obtained with the same mathematic formula as the one used in the first situation.

Such a configuration is more particularly adapted to perforated ceramics of the radiating panel burners, the injection channels of which have small dimensions.

Control diaphragms 9 can also be provided in the injection channels upstream of the swirling elements 17 (FIGS. 8, 9 and 10A and 10B). Such elements make it possible to create depression zones in zone 3 which favours the starting of flames.

In other cases of configurations of multi-point injectors having large dimensions, it may be advantageous to position in the injection channels an obstacle (a “bluff body”) which is used as a flame starter. The obstacle 18 illustrated in FIGS. 11 to 13 and 14A to 14B consists of a coaxial rod extending longitudinally in the channel. This rod makes it possible to create a flow recirculation zone facilitating the stabilisation of flames in space.

In FIGS. 15, 16 and 17A and 17B, the control means consist of a panel 19 positioned transversally in a flow conduit 20 connecting an inlet chamber 21 to a zone 22 where the combustion occurs. The panel 19 comprises a surface 23 in which wells 24 are arranged in such a way as to form transversal surfaces 23, 25 offset with respect to each other. Each surface 23, 25 is provided with a control opening 26.

The invention is described hereabove as an example. It should be noted that the persons skilled in the art may provide various alternative embodiments of the invention without leaving the scope thereof.

1. A multi-point device for injecting fuel or a fuel/oxidiser pre-mixture into a combustion zone arranged downstream of said device in such a way as to form flames, the device comprising at least one conduit for the flow of the fuel or the pre-mixture towards the combustion zone and means for controlling the flow of the fuel or the pre-mixture running into the combustion zone, characterised in that the control means are arranged in such a way as to form a sudden localised variation in diameter of the flow conduit defining in the flow conduit at least two control openings having a non-null determined longitudinal offset ΔX and creating, in forced state operation, annular swirls downstream of the variation in diameter, in such a way that in response to an acoustic load, the flames formed in the combustion zone, respectively at the outlet of each control opening, oscillate out of phase.

2. An injection device according to claim 1, characterised in that the flow conduit comprises a plurality of injection channels provided with one outlet in the combustion zone, and in that the control means comprise diaphragms respectively positioned transversally in an associated injection channel, with the openings of said diaphragms forming the control openings.

3. An injection device according to claim 2, characterised in that half the diaphragms are placed at a distance X1 from the outlets of the associated injection channels, with the other half being located at a distance X2 from the outlet of the injection channels, X2 being different from X1 so as to show a non-null determined offset ΔX.

4. An injection device according to claim 2, characterised in that the diaphragms have an identical opening diameter.

5. An injection device according to claim 1, characterised in that the flow conduit is provided with two series of injection channels respectively provided with one outlet in the combustion zone, with the injection channels of each series comprising an internal wall having a sudden localised enlargement respectively at a different distance from the outlets L12 and L22 in such a way as to have longitudinally offset enlargements, said enlargements forming the control openings.

6. An injection device according to claim 2, characterised in that it further comprises swirling elements positioned in the injection channels, downstream of said control openings.

7. An injection device according to claim 2, characterised in that it further comprises rod-shaped recirculation elements longitudinally extending into the injection channel.

8. An injection device according to claim 1, characterised in that the control means comprise a panel positioned transversally in the flow conduit, said panel comprising a surface in which wells are arranged in such a way as to form transversal surfaces offset with respect to each other, with each one of the surfaces being provided with a control opening.

9. An injection device according to claim 1, characterised in that it further comprises one swirling element positioned in the flow conduit, downstream of said control means.

10. A combustion system comprising a combustion zone associated with an injection device according to claim 1.

11. An injection device according to claim 3, characterised in that the diaphragms have an identical opening diameter.

12. An injection device according to claim 8, characterised in that it further comprises one swirling element positioned in the flow conduit, downstream of said control means.
